(19) United States
(12) Patent Application Publication
(10) Pub. No.: US 2004/0188109 A1
(43) Pub. Date: Sep. 30, 2004

(54) Road-legal disc harrow

(76) Inventor: Bernard O. Domries, Madera, CA (US)

Correspondence Address: John P. Sutton, 2421 Pierce Street, San Francisco, CA, 94115, US

(21) Appl. No.: 10/776,738

(22) Filed: Feb. 12, 2004

Related U.S. Application Data
(63) Continuation-in-part of application No. 10/071,410, filed on Feb. 8, 2002.

(51) Int. Cl. A01B 49/00

(52) U.S. Cl. 172/311

(57) ABSTRACT

A farm implement convertible between a work position and a transport position is disclosed. In the transport position, a compact package is formed no more than eight feet in width, no more than 14 feet in height and no more than 40 feet in length. Right and left wings connected to the main frame may be raised by pushing articulated arms a short distance to fold the wings above the main frame

This application is a continuation-in-part of U.S. application Ser. No. 10/071,410.

### FIELD OF THE INVENTION

This invention relates to transportable farm implements. Although the title designates the preferred embodiment of a disc harrow, the apparatus is suitable for suspending any number of work tools from the structure, such as sprayers, fertilizers, planters, tillers, etc. The apparatus is convertible from a working mode, in which wings are spread to a maximum width to permit farm operations to cover a wide swath with each pass, and a transport mode, in which the wings are folded into a compact width and height such that is can legally be transported on roads and highways without special permits, escorts, lighting, or hours of transporting.

By “road-legal,” I mean an implement that can be transported on highways at highway speeds on a normal semitrailer of conventional length and width, without “wide load” signs, flashing lights, escort vehicles, or hours of transporting as required by government regulatory agencies. The requirements of the agencies vary from state to state. Road-legal is intended to meet the requirements of all regulatory agencies. In order to give a specific example of dimensions that are road-legal everywhere, I describe an envelope that is eight feet wide, forty feet long and fourteen feet from road to the highest point on the trailer. These dimensions are used for most manufacturers of semi-trailers and are thus an industry standard. However, it is my intent to include within the scope of this invention dimensions that are legal in any particular jurisdiction. For example, if a jurisdiction allows a width of 8 and ½ feet, it is my intent to have an implement 8 and ½ feet deemed road-legal and equivalent to the envelope here described. For purposes of the invention, there is no difference between 8 and 8 and ½ feet. There is, however, a difference between 8 and 12 feet, because the latter is not road-legal anywhere at highway speeds without special precautions. It is also important that the implement be foldable to fit within the envelope without disassembly.

### BACKGROUND OF THE INVENTION

The prior art contains numerous patents for farm implements that are convertible between a transport mode and a use mode. Thus, U.S. Pat. No. 5,715,893 discloses a towable farm implement having wings that are lifted on a turntable and rotated 90 degrees, so that the wings that extend laterally in the use mode are lifted and rotated to fore and aft positions extending from the turntable. FIG. 9 of that patent shows a long tongue member 24 for hitching to a tractor to tow the implement from a storage location to a use location. Such an apparatus could not be transported on a highway from a manufacturing site to a customer without special permits, escorts and hours of transportation. The implement in transport mode in the '893 patent far exceeds forty feet in length.

Similarly, U.S. Pat. No. 3,620,550 appears to be over 40 feet in length and over 8 feet in width, although the patent gives no dimensions. More importantly, the '550 patent shows an implement that is not foldable. As shown in column 6, line 21 to column 7, line 2, the parts must be entirely disconnected for transportation and reassembled for the work mode. It is not foldable without disassembly.

U.S. Pat. No. 6,112,827 also fails to disclose any dimensions, but it appears to be over 40 feet long and over 8 feet wide. In any event, it is not built to pass at highway speeds on a semitrailer, because column 1, lines 54-55 and 65-70 show that it is simply moved from one field to another, not from the manufacturing site to the customer. Similarly U.S. Pat. No. 3,990,521 shows an implement to be towed from one field to another by tractor 2, not transported on a semitrailer at highway speeds.

U.S. Pat. No. 4,159,038 discloses an earthworking implement having foldable wings to allow movement of “implements that are over ten meters or more wide from one field to another” (column 1, lines 15-16).

Similarly U.S. Pat. No. 3,692,121 shows liftable wings that can be raised to a position over the main frame, but the main frame is not road-legal, so the apparatus cannot be transported over the highway from the manufacturer to the user without special permits. Both of these prior art patents use fluid cylinders of long thrust to lift the wings (82 in the '038 patent and 42 in '121).

Likewise, U.S. Pat. No. 4,479,554 has a main frame that is not road-legal, so lifting the wings cannot make it road-legal. Moreover, a piston cylinder 110 has a long thrust in this patent.

There are many other patents that have the words “road” or “highway” in the specification, but they do not describe an implement that can fit within the road-legal envelope for transport on a semi trailer at highway speeds. The following patents are all over 8 feet wide in the folded transport mode: U.S. Pat. Nos. 3,651,870; 4,034,623; 4,128,131; 4,335,689; 4,364,581; 4,415,043; 4,921,809; 4,971,154; 6,371,215; 6,374,921; 6,408,950; and 6,550,543.

### SUMMARY OF THE INVENTION

The present invention provides a road-legal farm implement that can be expanded to work a wide swath by activating a fluid pressure cylinder powered by the hydraulic system of the towing vehicle as is common in the art. A bridge above the main frame holds a fluid cylinder that pushes lifting arms to raise wings to a location above the main frame within a road-legal envelope. The basic frame is approximately eight feet in width with dependent work implements. The wings, when lowered to the work position, extend approximately eight feet each, one laterally extending forward of the main frame and the other extending laterally rearward from the main frame. Two sets of wings may be added to a tandem harrow on the main frame. Each wing is raised by a single small hydraulic cylinder with a stroke as short as eight inches and a bore of approximately three inches. When in the transport position, wheels located in width slightly less than the road-legal width provide maximum stability while being transported. All wings are folded above the wheels so that no part of the wings or other elements of the apparatus extends beyond the plane formed vertically from the outer edges of the wheels.

### BRIEF DESCRIPTION OF THE DRAWINGS

FIG. 1 is an isometric view of the main frame that supports the apparatus.

FIG. 2 is a front elevation view of the front wing assembly and main gang in the work position.

FIG. 3 is an isometric view of the bridge assembly.

FIG. 4 is a front elevation view of the front wing assembly and main gang in the transport position.

FIG. 5 is an isometric view of the hitch assembly.

FIG. 6 is an elevation view of an alternate hold-down assembly.

### DESCRIPTION OF THE PREFERRED EMBODIMENTS

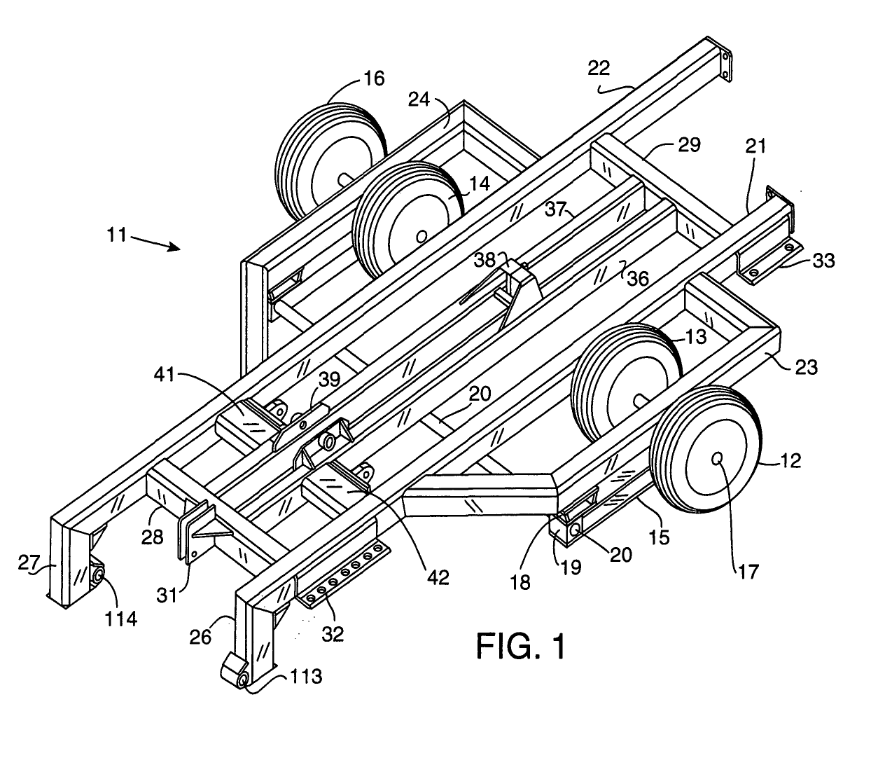

FIG. 1 illustrates the main frame 11 that rides on a sufficient number of wheels with pneumatic tires to support the weight of the apparatus. I have found that four 15″×18″ wheels 12, 13, 14 and 16, mounted on axle 17 transversely to the main frame 11 are sufficient to support the weight of the apparatus in the transport mode. 9.5L tires are suitable. Axle 17 rides on axle blocks, one of which is shown at 18 in FIG. 1. Wheels 12, 13, 14 and 16 are rotatable from a tilling position in which the work implements engage the soil (the “up” position) and a transport position in which the wheels engage the surface being traversed (the “down” position). As shown in FIG. 1, axle block 18 carries blocks 19 which support rod 20. Welded plates 15 engage rod 20 to permit rotation of rod 20 between the up position and the down position. Each wheel 12, 13, 14 and 16 rotates about an axle 17, which is carried on plate 15 attached to rod 20, which rotates in the series of blocks 19, to place wheels and implements in the desired transport or work position.

Frame 11 consists of two main parallel rails 21 and 22 inboard of the outer wheels 12 and 16 as the primary load bearing elements running longitudinally front to rear. At the front ends of rails 21 and 22 are hangers 26 and 27 from which a conventional hitch (not shown) depends for towing by a tractor or other towing vehicle. Outboard of the rails 21 and 22 are stabilizers 23 and 24. Stabilizer 23 carries axle block 18 and encloses wheel 12 to provide maximum stability in the transport mode. Stabilizer 23 also supports the wing assemblies presently to be described in a manner to minimize roll in the transport mode. Stabilizer 24 operates in the same way as stabilizer 23, but on the right side.

Rails 21 and 22 are separated by forward cross member 28 and rear cross member 29. Forward cross member 28 supports a center mount 31 for the hitch (not shown). Rail 21 supports gang attachment 32 for the forward gang of discs or other farm implements supported by the main frame. Multiple holes in gang attachment 32 allow for adjustable angles for the main gang relative to the direction of towing in the work position. A pin (not shown) permits the user to select the desired hole for the angle needed for the work task, as is conventional. Gang attachment 33 is mounted on the rear of rail 21 to accommodate the rear gang of work implements attached to the main frame. Following discs on tandem harrows typically require less adjustment, so rear gang attachment 33 has fewer holes.

Between main rails 21 and 22 are inboard rails 36 and 37 that support a conventional wheel raising apparatus to lift the wheels from the lower transport position to the raised work position in which the discs or other farm implements can engage the soil. Wheel 13 rides between rail 21 and rail 36, and wheel 14 rides between rail 37 and rail 22. A conventional hydraulic wheel raising attachment (not shown) is mounted on rails 36 and 37 at rear mount 38 and forward mount 39. Because the load in raising the wheels is primarily borne on the front mount 39, there are additional wheel-raising cross members 41 and 42 to carry the load to the main rails 21 and 22.

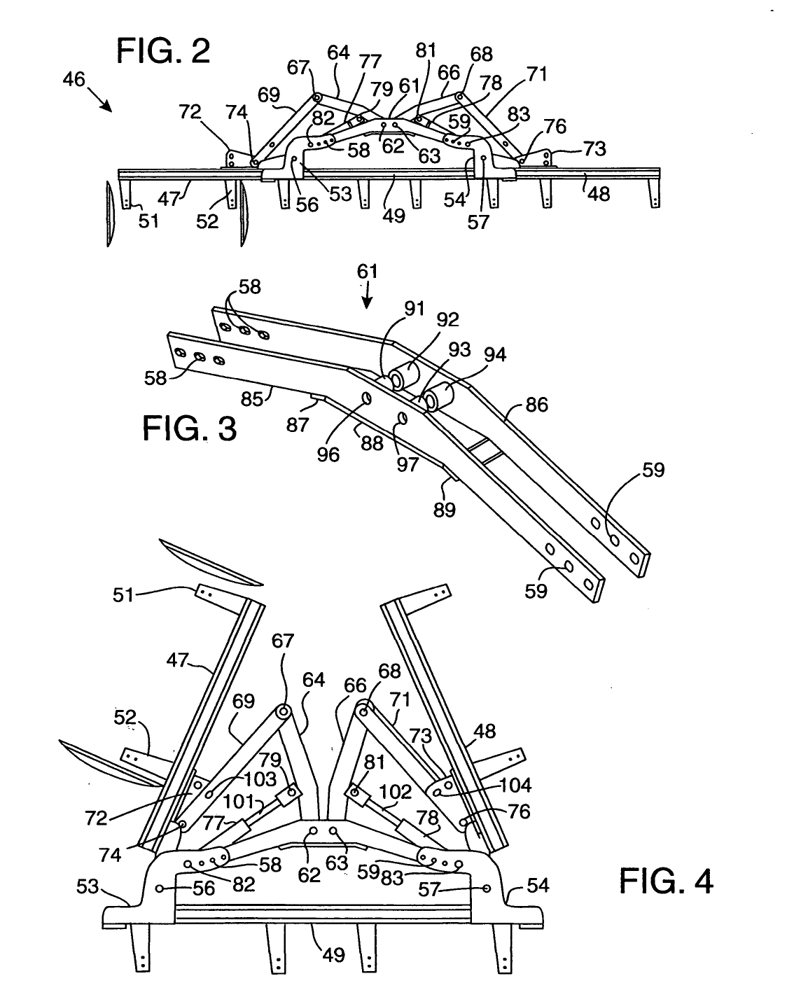

FIG. 2 illustrates the front wing assembly 46 in the work position with wings 47 and 48 extended from main gang 49 in a continuous array of work implements. Each of wings 47 and 48 and main gang 49 has a desired number of discs or work implements dependent therefrom. FIG. 2 only shows two discs rotatable in blocks 51 and 52, but it will be understood that any number of implements and blocks may be attached to gangs 47, 48 and 49. As is conventional in tandem disc harrows, the forward discs turn soil over in one direction and rear discs turn the soil in the opposite direction. Accordingly, the rear wing assembly (not shown) is identical to the front wing assembly in FIG. 2 except that the discs are in the opposite direction.

Wings 47 and 48 each have brackets 53 and 54, respectively, welded to the beam to provide pivot pins 56 and 57, respectively, for raising the wings 47 and 48. Brackets 53 and 54 allow the main frame 11 (FIG. 1) to extend between brackets 53 and 54 above main gang 49, which is releasably attached to the main frame (not shown in FIG. 2). Each of brackets 53 and 54 is attached by one or more bolts 58 and 59 to bridge assembly 61 spanning the space above main frame 11 and anchoring pivot pins 62 and 63 about which upper arms 64 and 66 pivot.

Upper arms 64 and 66 are connected, through elbows 67 and 68, respectively, to lower arms 69 and 71, which are, in turn, attached to braces 72 and 73, respectively, welded to wings 47 and 48. Braces 72 and 73 have holes into which pins 74 and 76 are inserted to provide pivot points for lower arms 69 and 71, respectively.

Lifting of wings 47 and 48 is accomplished by hydraulic cylinders 77 and 78 for each wing connected to the hydraulic system of the towing vehicle. Cylinders 77 and 78 are relatively small, given the weight of the apparatus, and achieve the lifting task by pushing upper arms 64 and 66 upwardly about pivot points 62 and 63. I prefer a hydraulic cylinder with a stroke of less than 12 inches, with an 8 inch stroke and 3 inch bore being optimum. The cylinders 77 and 78 are shown in FIG. 2 in a closed position, with the rod of cylinder 77 attached to pin 79 through a projection in upper arm 64. Likewise, Cylinder 78 is attached to pin 81 in a projection of upper arm 66. Cylinder 77, at its lower end, is attached to pin 82 in bracket 53. Cylinder 78 has a corresponding pin 83 in bracket 54.

When cylinders 77 and 78 are activated, they push upper arms 64 and 66 upwardly through pins 79 and 81, respectively to cause arms 64 and 66 to rotate about pins 62 and 63. Lower arms 69 and 71 also raise, pivoting about elbows 67 and 68, at the upper end, and pins 74 and 76 at the lower end. The movement of only eight inches of the piston rods in cylinders 77 and 78 is sufficient to raise wings 47 and 48 to a position for transport inside the vertical plane defined by the outer limits of stabilizers 23 and 24 (FIG. 1).

FIG. 3 is a detail of the bridge assembly 61 shown in FIG. 2. Bridge 61 has two parallel plates 85 and 86 of identical configuration. One or more holes 58 and 59 are formed in the outward ends of the plates 85 and 86 to adjustably attach to corresponding holes 58 and 59 in brackets 53 and 54 (FIG. 2). Plates 85 and 86 are connected by welded plates 87, 88 and 89 to keep them rigidly parallel. The pivot pins 62 and 63 of FIG. 2 are accommodated by tubes 91, 92, 93 and 94 aligned with holes 96 and 97 in plate 85. Corresponding holes (not shown) are in plate 86. This reinforcement serves to enhance the main load-bearing pivot pins 62 and 63.

FIG. 4 shows the assembly of FIG. 2 in a folded position for transport. Cylinders 77 and 78 have their rods 101 and 102 extended less than twelve inches. This raises upper arms 64 and 66 by pushing on pins 79 and 81 attached to projections on arms 64 and 66. Lower arms 69 and 71 extend between elbows 67 and 68 and pins 74 and 76 in braces 72 and 73, respectively. In the folded position, locking pins 103 and 104 pass through each of lower arms 69 and 71 and braces 72 and 73 to prevent wings 47 and 48 from accidentally jarring loose from the folded position.

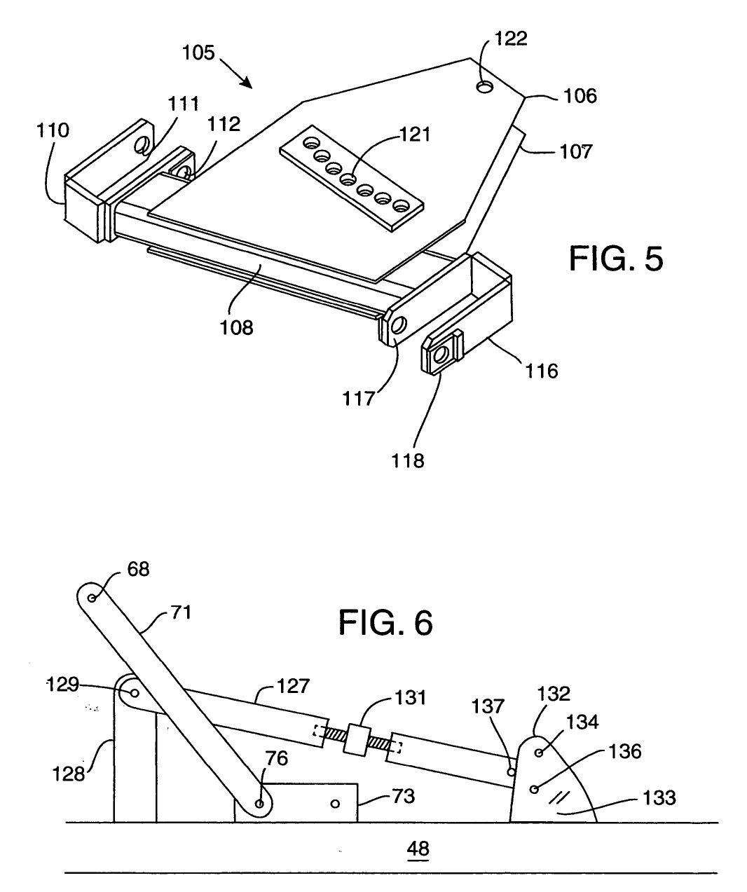

FIG. 5 illustrates the hitch assembly 105 for towing the apparatus in either the work position or the folded transport position. Parallel plates 106 and 107 are welded to cross member 108 forward of main frame 11 (FIG. 1). In FIG. 1, the left side is the forward end of the frame and the right side is the aft end of frame 11. In FIG. 5, however, the left side is the aft end of the hitch assembly 105 and the right side is the front end, the opposite of FIG. 1. Thus, forward facing U-shaped brace 110 has holes 111 and 112 that permit a pin (not shown) to extend through each hole and tube 113 at the front end of hanger 26 (FIG. 1) to secure the left side of the hitch to the left side of the main frame 11. Similarly, U-shaped brace 116 on hitch assembly 105 extends rearwardly to embrace hanger 27 and tube 114 (FIG. 1) to permit a pin (not shown) to extend between holes 117 and 118 through tube 114, whereby the right side of hitch assembly is attached to hanger 27 of frame 11. A plurality of holes 121 permit the hitch assembly 105 to be adjustably secured to the towing vehicle for the desired pitch of the working implements in relation to the ground. Hole 122 allows a pin to attach a tongue (not shown) connecting the hitch to the towing vehicle.

FIG. 6 shows an alternate hold-down assembly to hold down wings in the work position, while permitting them to flex when being raised or lowered. As illustrated in FIG. 2, lower arm 71 is secured to brace 73 by means of pin 76. While this configuration is suitable for work applications, it does not permit the wing 48 to flex as it is being folded up or down. In a preferred embodiment, I use an additional hold-down assembly 126 outboard of the brace 73. Assembly 126 consists of an arm 127 extending between a riser 128 secured to wing 48, as by welding. Arm 127 pivots on pin 129 extending through riser 128. Arm 127 is in two parts separated by turnbuckle 131, allowing the two parts to be adjusted in length. Arm 127 extends through box 132, consisting of two parallel welded plates, only one of which is shown at 133, secured to wing 48, as by welding. Arm 127 slidably passes through the box 132 as the wing 48 flexes during raising and lowering. Box 132 is formed by the two plates 133, upper pin 134 and lower pin 136 separating the plates 133. Given the length of wing 48 and the flexibility of steel, arm 127 can be adjusted by turnbuckle 131 to allow arm 127 to pass through box 132 to the extent necessary. When the wing 48 is lowered to the work position, it may be held down solid and immovable by placing a pin (not shown) in hole 137. The pin engages box 132 to prevent arm 127 from sliding through between plates 133, making it immovable, barring the flexing of wing 48 in the work position.

The road-legal requirements for transporting on roads and highways vary by jurisdiction. It is the intent of this invention to comply with the legal requirements of all jurisdictions. As an example, many jurisdictions will permit loads on roads without escorts, wide load signs, or special permits if they do not exceed eight feet in width nor fourteen feet in height. However, because these limitations may change over time, I do not want to be limited to this particular example.

The embodiments described above have been described with particularity to enable one skilled in the art to make and use them. Modifications and changes from these embodiments may be made by one having ordinary skill in the art without departing from the inventive concepts defined in the claims.

1. A farm implement capable of being transported on highways at highway speeds within an envelope approximately eight feet wide, forty feet long and fourteen feet above road level comprising (1) a central section having a width less than about eight feet, said central section consisting of a frame carrying at least one gang of farm instruments for work on soil or plants; (2) at least one left wing mounted on the central section, said wing having a gang of farm instruments dependent therefrom and movable between (a) a work mode wherein the instruments engage soil or plants and (b) a transport mode wherein the wing is lifted above the central section to a location within the said legal width of the central section; (3) at least one right wing mounted on the central section, said wing having a gang of farm instruments dependent therefrom and movable between (a) a work mode wherein the instruments engage soil or plants and (b) a transport mode wherein the wing is lifted above the central section to a location within about eight feet in width above the central section; (4) a hydraulic system for lifting the wings connected to an external source of hydraulic power; and (5) at least two lifting mechanisms for lifting left and right wings to a road-legal location above the central section for lifting the left gang and the right gang to a position above the central section that is road-legal.

2. A farm implement as in claim 1 wherein each lifting mechanism consists of a hydraulic cylinder secured to the central frame that pushes an articulated arm cooperating with said wing upward to raise the wing to a position above the central section.

3. A farm implement as in claim 4 wherein the hydraulic cylinder has a bore of approximately three inches and a stroke of approximately eight inches.

4. A farm implement as in claim 1 wherein the frame of the central section carries an axle supporting wheels for transporting the farm implement, said axles capable of being lowered to a transport position or raised to a work position in which the instruments engage in work.

5. A farm implement as in claim 1 wherein each wing has a hold-down linkage that permits the wing to flex when rising or lowering said linkage consisting of a support arm adjustably attached to the central frame on one end and slidably engaged to a hold-down box on the wing, whereby the support arm slides in and out of a hold-down box on the wing as the wing flexes.

6. A farm implement comprising (1) a central section having a width of about eight feet consisting of a frame from which are suspended a forward gang of farm instruments and a rear gang of instruments; (2) a left wing mounted on said central section having a forward gang of instruments cooperating with the forward gang of instruments on the central section and a rear gang of instruments cooperating with the rear gang of instruments on the central section; (3) a right wing mounted on said central section having a forward gang of instruments cooperating with the forward gang of instruments on the central section and a rear gang of instruments cooperating with the rear gang of instruments on the central section; (4) a hydraulic system connected to an external source of hydraulic power; and (5) four lifting mechanisms powered by the hydraulic system for lifting the left front and rear gangs and the right front and rear gangs to a position above the central section that is less than eight feet wide and fourteen feet above the road.

7. A farm implement as in claim 6 wherein the gangs of instruments constitute tandem disc harrows.

8. A farm implement as in claim 6 wherein the four lifting mechanisms are four hydraulic cylinders, each having a bore of approximately three inches and a stroke less than twelve inches, raise each of the front and rear left gangs and the front and rear right gangs.

9. A farm implement as in claim 6 wherein the forward gangs on the two wings and in the central section are adjustably mounted relative to the path of travel of the implement to adjust the work performed by the instruments on the soil.

10. A farm implement as in claim 6 wherein the central section is supported by wheels in the transport mode with the wings lifted, said wheels being retracted in the work mode to enable the implement to be supported by the farm instruments engaging the soil.

11. A farm implement as in claim 6 wherein each of the wings is equipped with a hold-down mechanism operating in either a locked position in the work mode or in a flex position in the transition to and from the transport mode, said flex position comprising an arm cooperating with the central section and slidably engaged with a wing-mounted hold-down to permit the wings to flex while being raised or lowered.

12. A farm implement as in claim 6 wherein each wing is raised by pushing upper and lower arms inwardly, said arms pivoting about an elbow connecting them, said upper arm cooperating with a lifting mechanism and said lower arm cooperating with the wing, and the locking pin securing each lower arm to the corresponding raised wing in the transport mode, whereby the wings cannot be accidentally lowered during transport.
